(19) United States
(12) Patent Application Publication
(10) Pub. No.: US 2011/0202273 A1
(43) Pub. Date: Aug. 18, 2011

(54) METHOD AND APPARATUS FOR TRANSMITTING AND RECEIVING MAP DATA

(75) Inventors: Igor NOGTEV, Suwon-si (KR); Jeong Hwan AHN, Suwon-si (KR); Min Su AHN, Seoul (KR); Ki Cheol LEE, Hwaseong-si (KR); Jae Bok LEE, Seongnam-si (KR)

(73) Assignee: SAMSUNG ELECTRONICS CO., LTD., Suwon-si (KR)

(21) Appl. No.: 12/958,665

(22) Filed: Dec. 2, 2010

(30) Foreign Application Priority Data
Feb. 12, 2010 (KR) 10-2010-0013182

(51) Int. Cl. G01C 21/00; G06F 17/00

(52) U.S. Cl. 701/208; 701/200; 707/693; 707/E17.002

(57) ABSTRACT

A navigation system compresses original map data to generate compressed map data. The navigation system compares a size of the original map data with a size of the compressed map data and selectively transmits the original map data or the compressed map data based on the comparison.

### CROSS-REFERENCE TO RELATED APPLICATIONS

This application claims priority under 35 U.S.C. §119 to Korean Patent Application No. 10-2010-0013182 filed on Feb. 12, 2010, the disclosure of which is hereby incorporated by reference in its entirety.

### BACKGROUND

Embodiments of the inventive concept relate generally to navigation systems. More particularly, embodiments of the inventive concept relate to methods and apparatuses for transmitting and receiving map data in navigation systems.

Navigation systems display information to help users navigate between different locations. For instance, certain navigation systems display geographic information, such as maps, together with a user's current location and a route from the current location to a desired destination.

The geographic information can include various forms of data, including two-dimensional and three-dimensional features of an area, names of roads and businesses, geographic coordinates, photographs and videos taken at various locations, and other forms of information. Moreover, many navigation systems allow a user to select or adjust the displayed geographic information for a particular purpose, such as driving directions, house hunting, restaurant searches, and so on.

Navigation systems come in a variety of forms, such as automobile navigation systems and mobile phone navigation systems. Although many of these systems can store large amounts of information, there is a continuing demand to increase the amount of stored information. Because many navigation systems comprise relatively small mobile devices with limited amounts of data storage, it can be difficult for these devices to keep up with the increasing demand for more information storage.

### SUMMARY

Embodiments of the inventive concept provide methods and apparatuses for transmitting and receiving map data in a navigation system. Some of these embodiments allow the navigation system to display larger amounts of map data compared with conventional methods and apparatuses.

According to one embodiment of the inventive concept, an apparatus for transmitting map data comprises a memory that stores original map data, an encoder that encodes the original map data to generate compressed map data, and a map data generator that selects the original map data or the compressed map data based on a size of the compressed map data relative to the original map data, and stores the selected map data in the memory. The apparatus further comprises an index table generator that generates an index table comprising compression information indicating whether the selected map data is compressed map data, and a transmitter that transmits the selected map data and the index table.

In certain embodiments, the apparatus further comprises a parser that extracts the original map data from the memory as a cell unit, and provides the extracted original map data to the encoder, wherein the cell unit is a unit lattice structure of a map.

In certain embodiments, the memory comprises an original cell buffer that stores the original map data as the cell unit and a compressed cell buffer that stores the compressed map data as a cell unit.

In certain embodiments, the map data generator selects the compressed map data upon determining that the compressed map data has a smaller size than the original map data.

In certain embodiments, the map data comprises three-dimensional topographical information.

In certain embodiments, the map data generator receives the original map data from the parser and receives the compressed map data from the encoder and compares the size of the compressed map data with a size of the original map data.

In certain embodiments, the encoder compresses the original map data using moving picture experts group-4 compression.

In certain embodiments, the index table further comprises a cell identifier indicating a location of the selected map data within a map image.

In certain embodiments, the index table further comprises an offset indicating a location of the original cell buffer or the compressed cell buffer.

In certain embodiments, the transmitter transmits the selected map information and the index table using wireless transmission.

According to another embodiment of the inventive concept, an apparatus for receiving map data comprises a memory and a receiver that receives location information, map data, and an index table. The apparatus further comprises a parser that, in response to a map recovery signal, identifies selected map data to be displayed by the apparatus, distinguishes different portions of the selected map data as original map data and compressed map data, and extracts the original map data from the memory. The apparatus still further comprises a decoder that decodes the compressed map data to generate decoded original map data, a map data recovery unit that generates the map recovery signal based on the location information, receives the extracted original map data from the parser and the decoded original map data from the decoder, and outputs the selected map data in the form of the extracted original map data and the decoded original map data. The apparatus still further comprises a map image generator that receives the selected map data output by the map data recovery unit and generates a map image from the selected map data, and a display unit that displays the generated map image.

In certain embodiments, the memory comprises an original cell buffer that stores the original map data in cell units and a compressed cell buffer that stores the compressed map data in cell units.

In certain embodiments, the parser distinguishes the different portions of the selected map data as original map data and compressed map data according to information stored in the index table.

In certain embodiments, the index table comprises cell identifiers for cells of map data.

In certain embodiments, the cell identifiers correspond to locations of the map data within the map image.

In certain embodiments, the apparatus is a portable navigation system.

According to one embodiment of the inventive concept, method is provided for operating a navigation system. The method comprises generating compressed map data by encoding original map data, comparing a size of the original map data with a size of the compressed map data, selecting the original map data or the compressed map data according to the comparison, generating an index table indicating whether the selected map data is compressed, and transmitting the selected map data and the index table.

In certain embodiments, generating the compressed map data comprises encoding a cell unit of the original map data to generate a cell unit of the compressed map data, wherein the cell unit is a unit of a lattice structure formed by dividing a map.

In certain embodiments, the method further comprises receiving location information indicating a location of a receiving apparatus, receiving the selected map data and the index table, and storing the received selected map data in a memory. The method of these embodiments still further comprises, identifying display data comprising map data to be displayed by the receiving apparatus, identifying different portions of the display data as original map data and compressed map data according to the index table, decoding the portions of display data identified as compressed map data, and recovering from the memory the portions of display data identified as original map data. The method of these embodiments still further comprises generating a map image from the decoded portion of the display data and the recovered portions of the display data, and displaying the generated map image.

In certain embodiments, the portions of display data identified as compressed map data are decoded in cell units corresponding to areas of an image lattice.

### BRIEF DESCRIPTION OF THE DRAWINGS

The drawings illustrate selected embodiments of the inventive concept. In the drawings, like reference numbers indicate like features.

FIG. 1 is a diagram illustrating a navigation system according to an embodiment of the inventive concept.

FIG. 2 is a diagram illustrating an example of a map data transmitting apparatus shown in FIG. 1.

FIG. 3 is a diagram illustrating an example of a map data receiving apparatus shown in FIG. 1.

FIG. 4 is a diagram illustrating a cell of map data according to an embodiment of the inventive concept.

FIG. 5 is a diagram illustrating multiple cells of map data according to an embodiment of the inventive concept.

FIG. 6 is a diagram illustrating locations of cell identifiers on a map according to an embodiment of the inventive concept.

FIG. 7 is a diagram illustrating cells with selected map data according to an embodiment of the inventive concept.

FIG. 8 is a diagram illustrating a data structure of a map according to an embodiment of the inventive concept.

FIG. 9 is a flowchart illustrating a method of operating the map data transmitting apparatus of FIG. 2.

FIG. 10 is a flowchart illustrating a method of operating the map data receiving apparatus of FIG. 3.

### DETAILED DESCRIPTION OF THE EMBODIMENTS

Embodiments of the inventive concept are described below with reference to the accompanying drawings. These embodiments are presented as teaching examples and should not be construed to limit the scope of the inventive concept.

The described embodiments relate generally to navigation systems and, more particularly, to methods and apparatuses for transmitting and receiving map data in navigation systems. In certain embodiments, map data is transmitted to a navigation system in a compressed or uncompressed form. The map data is transmitted in the compressed or uncompressed form according to compression characteristics of the map data, such as whether compression significantly reduces the size of the map data.

In the described embodiments, a map data transmitting/receiving apparatus transmits and receives map data comprising cells of a grid structure. However, in other embodiments, a map data transmitting/receiving apparatus can use map data having other forms or structures.

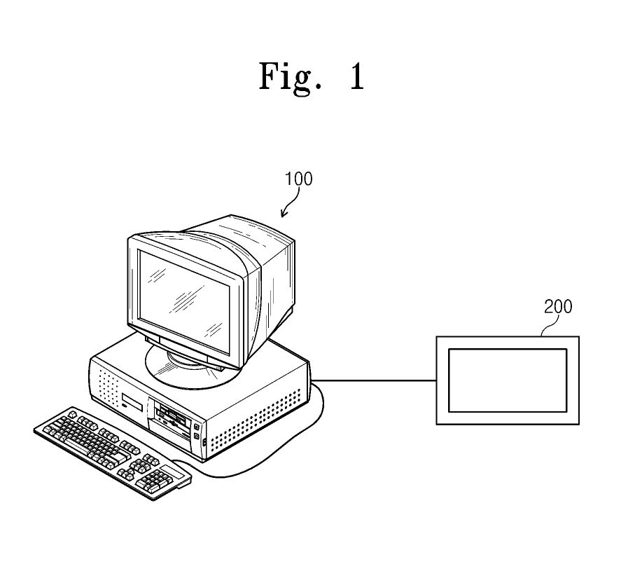

FIG. 1 is a diagram illustrating a navigation system according to an embodiment of the inventive concept.

Referring to FIG. 1, the navigation system comprises a map data transmitting apparatus 100 and a map data receiving apparatus 200.

Map data transmitting apparatus 100 transmits map data to map data receiving apparatus 200 to provide a navigation service. Map data receiving apparatus 200 receives the map data and displays geographic information based on the received map data and a current location of map data receiving apparatus 200.

Map data receiving apparatus 200 comprises a navigation apparatus providing a navigation service, and map data transmitting apparatus 100 comprises an external device for providing navigation information to map data receiving apparatus 200. Example embodiments of map data transmitting apparatus 100 include personal computers, notebooks, and various other types of electronic devices. Map data transmitting apparatus 100 and map data receiving apparatus 200 can transmit and receive data using wired or wireless communication.

Map data transmitted/received between map data transmitting apparatus 100 and map data receiving apparatus 200 can comprise two-dimensional map data, three-dimensional map data, and various forms of related information. The two-dimensional map data and three-dimensional map data can include models of a variety of natural and man-made geographic features, such as roads, buildings, rivers, lakes, coastal lines, boundaries, railroads, subways, ferries, structures, factories, and so on. The two-dimensional map data can comprise various two-dimensional features, such as footprints of structures and two-dimensional landmarks, and the three-dimensional map data can comprise various three-dimensional features, such as topography, three-dimensional building models, and three-dimensional landmarks.

The related information can comprise, among other things, location information and transportation information. The location information can comprise, for instance, street names, district numbers, building addresses, and geospatial coordinates. The transportation information can comprise, for instance, road sign locations, traffic signal locations, and traffic camera locations. Various other forms of related information include, for instance, filling stations, restaurants, hotels, companies, and advertisements.

In some embodiments, the map data is divided into spatial map data and non-spatial map data. The spatial map data can comprise two-dimensional map data and three-dimensional map data, while the non-spatial map data comprises other information such as names of locations and features, coordinates, and so on.

Map data transmitting apparatus 100 transmits map data in a compressed or uncompressed form according to whether compression can significantly reduce the size of the map data. In some examples, map data transmitting apparatus 100 is able to compress two-dimensional or three-dimensional map data from a relatively large size to a significantly smaller size. Accordingly, it transmits such map data to map data receiving apparatus 200 in a compressed form. In other examples, map data transmitting apparatus 100 is unable to compress two-dimensional or three-dimensional map data by a significant amount. Accordingly, it transmits such map data to map data receiving apparatus 200 in an uncompressed form.

In general, compression of map data can be efficient or inefficient according to characteristics of the map data. Accordingly, map data transmitting apparatus 100 transmits map data in a compressed form where efficient.

In addition to transmitting compressed or uncompressed map data, map data transmitting apparatus 100 also transmits compression information indicating whether the map data has been compressed. The compression information is used to recover the compressed map data.

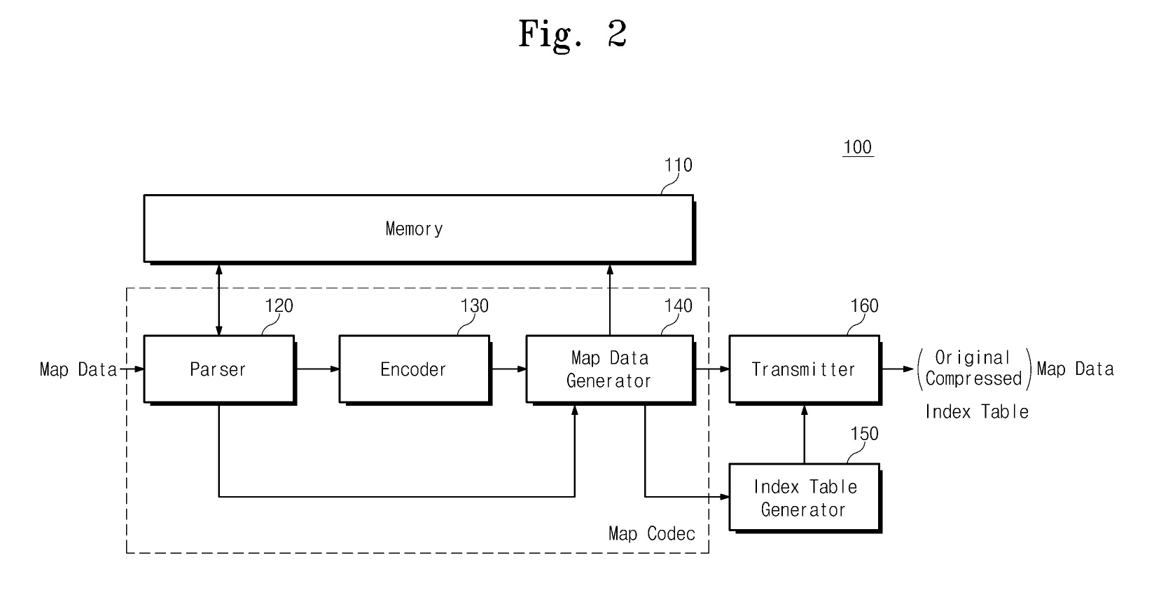

FIG. 2 is a diagram illustrating an example of map data transmitting apparatus 100 of FIG. 1.

In the example of FIG. 2, map data transmitting apparatus 100 comprises a memory 110, a parser 120, an encoder 130, a map data generator 140, an index table generator 150, and a transmitter 160. Parser 120, encoder 130, and map data generator 140 act as a map codec for generating compressed or uncompressed map data to be transmitted to map data receiving apparatus 200.

Map data is stored as cell units in memory 110. Memory 110 comprises a plurality of cell buffers each storing a cell of uncompressed map data (referred to as “original map data”), or compressed map data. The cell buffers can also be divided into an original cell buffer for storing cells of original map data and a compressed cell buffer for storing cells of compressed map data. Each cell comprises map data corresponding to features of a map, such as topographical information. Multiple cells can be arranged in a lattice or grid to form a map.

Parser 120 receives map data and stores the received map data in memory 110. The map data can be data from an external source, or data generated within map data transmitting apparatus 100. Parser 120 manages the map data by dividing the map data into cells and assigning a cell identifier to each cell.

Parser 120 also extracts original map data from memory 110 in cell units. For instance, parser 120 can extract the original map data from the original map buffers of memory 110. Parser 120 provides the extracted original map data to encoder 130 so that encoder 130 can generate compressed map data. Parser 120 also provides the extracted original map data to map data generator 140 so that map data generator 140 can compare the extracted original map data with the compressed map data generated by encoder 130.

Encoder 130 encodes the original map data received from parser 120 to generate compressed map data. Encoder 130 provides the generated compressed map data to map data generator 140.

Map data generator 140 compares the compressed map data from encoder 130 with the original map data from parser 120. The compressed map data and the original map data comprise the same map information and have the same cell identifiers. Map data generator 140 selects a smaller one of the original map data or the compressed map data and provides the selected map data to transmitter 160.

Map data generator 140 stores selected original map data in the original cell buffer of memory 110 and stores selected compressed map data in the compressed cell buffer of memory 110. More specifically, where the size of the compressed map data is smaller than the size of the original map data, map data generator 140 stores the compressed map data in the original cell buffer of memory 110. Where the size of the compressed map data is not smaller than the size of the original map data, map data generator 140 stores the original map data in the compressed cell buffer of memory 110. Where the size of the compressed map data is equal to the size of the original map data, map data generator 140 stores the original map data in the original cell buffer of memory 110. Map data generator 140 provides the selected map data to transmitter 160 and index table generator 150.

Index table generator 150 generates an index table corresponding to the selected map data provided from map data generator 140. The index table comprises meta-data from map data generator 140 or parser 120 that can be used by map data receiving apparatus 200 to process the selected map data. For instance, the index table can comprise cell identifiers, compression information, and offset information indicating a location of a cell within a cell buffer. The cell identifiers are used to reconstruct a map from individual cells of map data. The compression information indicates whether the map data has been compressed. The offset represents an offset of the selected map data from a reference cell in a cell buffer. The index table can record information regarding multiple cells in a cell buffer, and it enables rapid access to map data stored by cell unit.

Transmitter 160 transmits the index table and the selected map data to map data receiving apparatus 200.

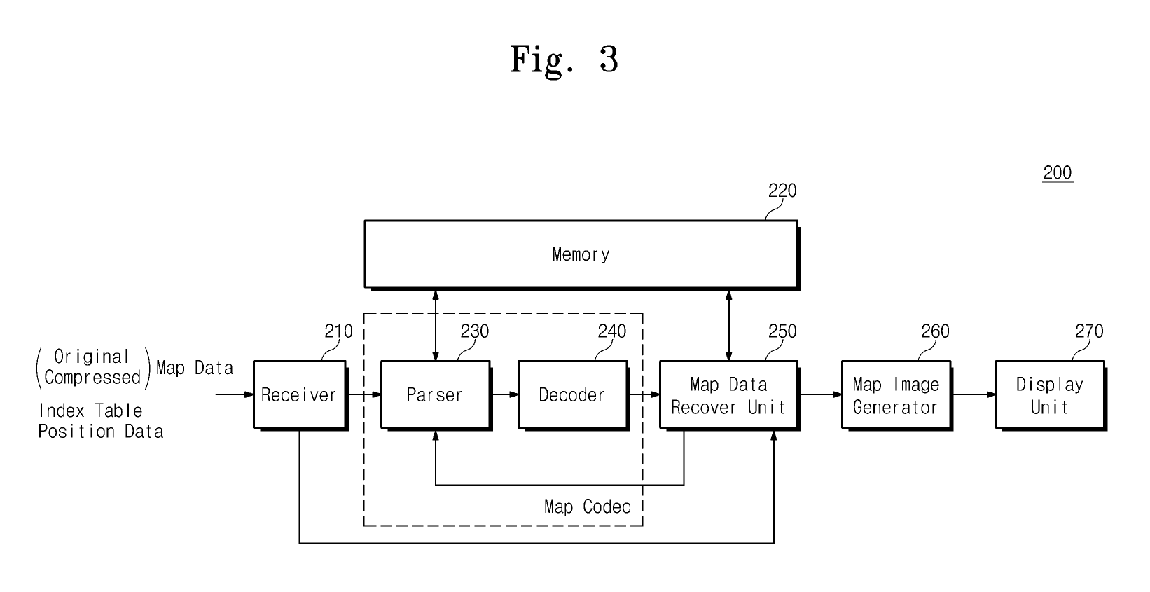

FIG. 3 is a diagram illustrating an example of map data receiving apparatus 200 shown in FIG. 1.

In the example of FIG. 3, map data receiving apparatus 200 comprises a receiver 210, a memory 220, a parser 230, a decoder 240, a map data recovery unit 250, a map image generator 260, and a display unit 270. Parser 230 and decoder 240 act as a map codec for decoding compressed map data from map data transmitting apparatus 100 to generate corresponding original map data.

Receiver 210 receives map data and an index table from map data transmitting apparatus 100. Receiver 210 can also receive location information of map data receiving apparatus 200 from a global positioning system (GPS) satellite. Receiver 210 transmits the index table and map data to parser 230 and transmits the index table and the location information to map data recovery unit 250.

Memory 220 stores the map data by cell unit in a plurality of cell buffers. In particular, memory 220 stores cells of original map data in an original cell buffer and stores cells of compressed map data in a compressed cell buffer. Memory 220 communicates with parser 230 and map data recovery unit 250 to transfer map data for various operations described below.

Parser 230 divides received map data into original map data and compressed map data and stores the original map data and the compressed map data in memory 220. Parser 230 uses the index table to divide the received map data into the original map data and the compressed map data. For example, parser 230 can divide the map data into the original map data and the compressed map data by referring to compression information corresponding to relevant cell identifiers.

Decoder 240 decodes compressed map data to generate original map data. In other words, decoder 240 decompresses the compressed map data.

Map data recovery unit 250 receives the location information and the index table from receiver 210 and selects map data to be displayed according to the location information. Map data recovery unit 250 also requests decoding of compressed map data from parser 230 based on the index table. Map data recovery unit 250 can receive original map data directly from memory 220 or from parser 230 by request. Map data recovery unit 250 provides information to parser 230 regarding received compressed map data. Parser 230 extracts the compressed map data from memory 220 via map data recovery unit 250. Parser 230 provides the extracted compressed map data to decoder 240.

Map data recovery unit 250 extracts original map data from memory 220 and receives original map data recovered from compressed map data by decoder 240. Map data recovery unit 250 combines the original map data from memory 220 with the original map data from decoder 240 and provides the combined map data to map image generator 260.

Map image generator 260 generates a map image from the combined map data provided by map data recovery unit 250. Map image generator 260 can generate the map image, for instance, by transforming coordinates of respective cells into a coordinate system used by display unit 270. Display unit 270 displays the map image generated in map image generator 260.

In the examples of FIGS. 2 and 3, map data receiving apparatus 200 receives map data from map data transmitting apparatus 100. However, in some embodiments, such as embodiments where memory 220 is detachable, map data can be transmitted from memory 220 to map data receiving apparatus 200.

Map data transmitting apparatus 100 and map data receiving apparatus 200 divide a map into cells (e.g., rectangular cells) that can be arranged in a grid or lattice to form a map image. In some embodiments, a single cell buffer included in a memory can store map data corresponding to one square cell. In other embodiments, a single cell buffer can store map data corresponding to multiple cells.

In some embodiments, map data receiving apparatus 200 displays map data by using a global coordinate system to position each cell of map data. In certain other embodiments, map data receiving apparatus 200 displays map data using a relative coordinate system that indicates a position of each cell relative to a reference position in a grid, such as a lower left corner.

By managing map data in cell units, map data transmitting apparatus 100 and map data receiving apparatus 200 can allow a portion of a map to be analyzed with relative efficiency.

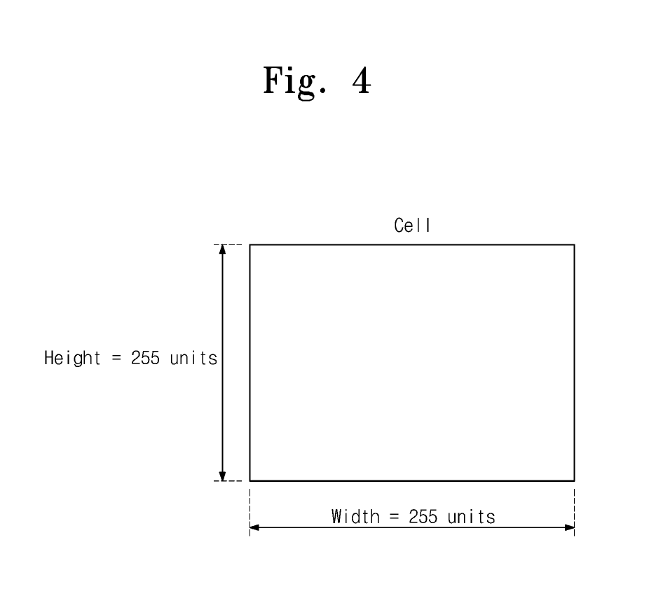

FIG. 4 is a diagram illustrating a cell of map data according to an embodiment of the inventive concept. In this embodiment, the cell has a square shape. However, the cell can take other forms in other embodiments.

The cell has a height and width corresponding to geographical units of a map, such as 1 cm, 1 m, 1 km, 10 km, 20 km, 50 km, or 100 km. As an example, where each unit of the cell corresponds to 1 km, the cell of FIG. 4 represents a geographical region that is 255 km high by 255 km wide.

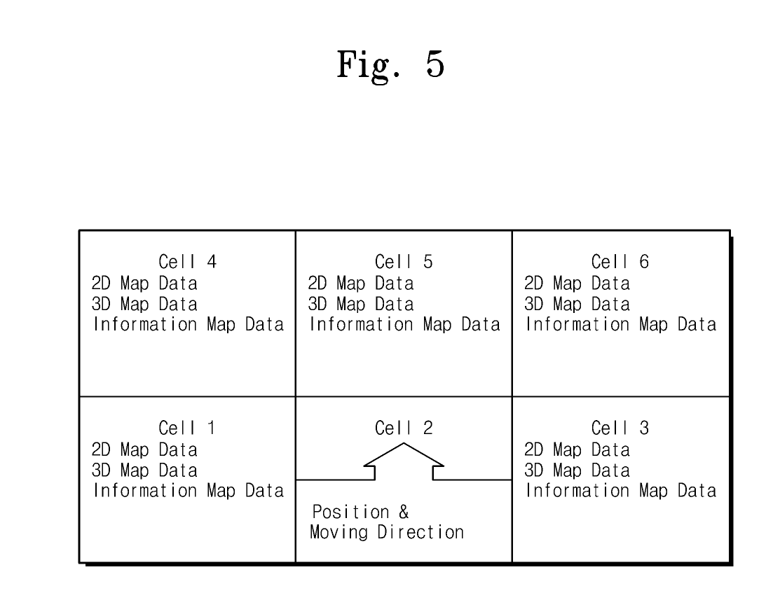

FIG. 5 is a diagram illustrating multiple cells forming a map according to an embodiment of the inventive concept. In particular, FIG. 5 shows cells 1 through 6 arranged in a grid or lattice structure. In this example, cells 1 and 3 through 6 comprise two-dimensional map data, three-dimensional map data, and information map data. Cell 2 comprises position and moving direction indicating a location, direction, and velocity of a vehicle equipped with map data receiving apparatus 200. Map data receiving apparatus 200 selects the second cell and uses the map data in the selected second cell to provide a navigation service.

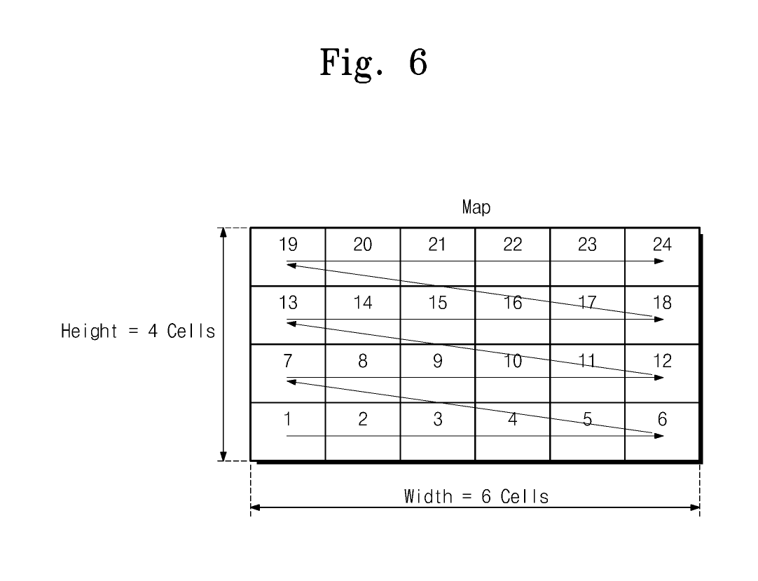

FIG. 6 is a diagram illustrating locations of cell identifiers on a map according to an embodiment of the inventive concept.

Referring to FIG. 6, a map has a height of four cells and a width of six cells. Accordingly, the map comprises 24 cells. Map data transmitting apparatus 100 assigns a cell identifier number 1 to a leftmost cell of a lowermost row and sequentially assigns serial numbers in a right direction. Where serial numbers are assigned to cells in one row, the following serial numbers are sequentially assigned to cells on another row located above the one row. The order of assignment of cell identifiers is indicated by arrows in FIG. 6.

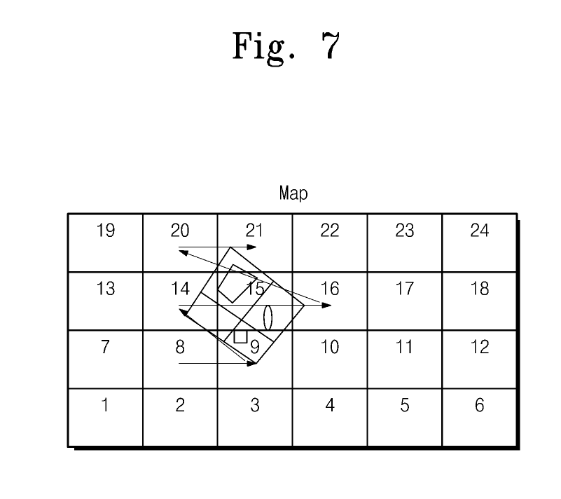

FIG. 7 is a diagram illustrating cells with selected map data according to an embodiment of the inventive concept. The selected map data is indicated by a four-sided polygon that covers portions of cells 8, 9, 14, 15, 16, 20, and 21.

In the example of FIG. 7, the selected map data is stored in cell buffers that can be identified according to the cell identifiers. Accordingly, the selected map data can be readily accessed according to the cell identifiers. Moreover, the cell buffers associated with the selected map data can be stored in a cell buffer table for convenient reference.

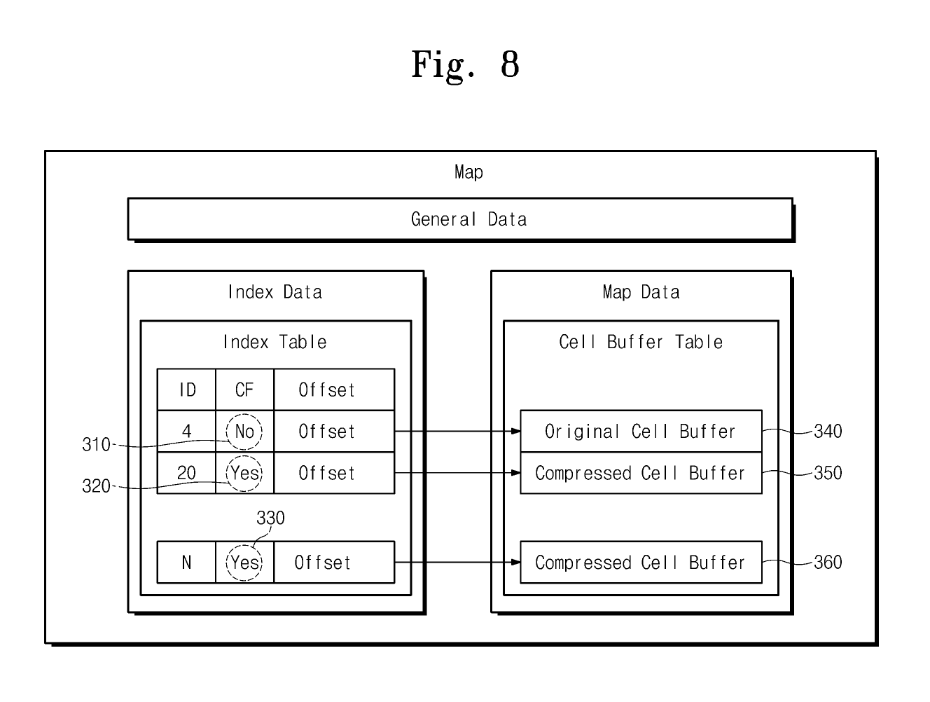

FIG. 8 is a diagram illustrating a data structure of a map according to an embodiment of the inventive concept.

Referring to FIG. 8, the data structure comprises general data, index data, and map data. The general data comprises an information type of the map data, cell scale characteristics (e.g., height and width), a cell buffer table size, a number of indices in the index table, and information necessary for decompression. The index data comprises cell identifiers, compression flags, and file offsets. The map data comprises a cell buffer table. The cell buffer table comprises original cell buffers and compression cell buffers, or comprises information regarding access to the original cell buffers and the compressed cell buffers.

The navigation system organizes the index data using an index table and organizes the map data using a cell buffer table. Where the map data is organized in the cell buffer table, the map data receiving apparatus can load corresponding map data quickly without analyzing the structure of the entire map data. Where the map uses a grid structure, it has a grid width and a grid height. The grid width and grid height can be measured in cell units.

The index table comprises information related to cell buffers of the cell buffer table. The respective cell buffers are divided into original cell buffers storing original map data and compressed cell buffers storing compressed map data. The index table comprises a plurality of entries, each corresponding to a corresponding entry of the cell buffer table. Each entry of the index table comprises an identifier (ID), a compression flag (CF), and an offset. The identifier can be used to identify a location of a cell on a map, such as those illustrated in FIGS. 6 and 7. The compression flag indicates whether a cell is compressed. The offset indicates a relative location of a map data file in a cell buffer. The sizes of the identifier, the compression flag, and the offset in the index table are shown in Table 1 below.

TABLE 1

| Field Name | Field Size |
|---|---|
| Cell buffer ID | 32 bits |
| Compression flag | 1 bit (sign bit) |
| Cell buffer offset | 31 bits |

In the example of Table 1, the cell buffer ID has a size of 32 bits, the compression flag has a size of 1 bit, and the cell buffer offset has a size of 31 bits. The compression flag requires only one bit to indicate whether a cell contains compressed or uncompressed map data. For example, a bit value ‘1’ can indicate that a cell includes compressed map data, while a bit value ‘0’ can indicate that the cell includes original map data.

In the example of FIG. 8, an original cell buffer 340 has an identifier value 4 and a compression flag value 310 indicating that corresponding map data has not been compressed. A compression cell buffer 350 has an identifier value 20 and a compression flag value 320 indicating that corresponding map data has been compressed. A compression cell buffer 360 has an identifier value N and a compression flag value 330 indicating that corresponding map data has not been compressed.

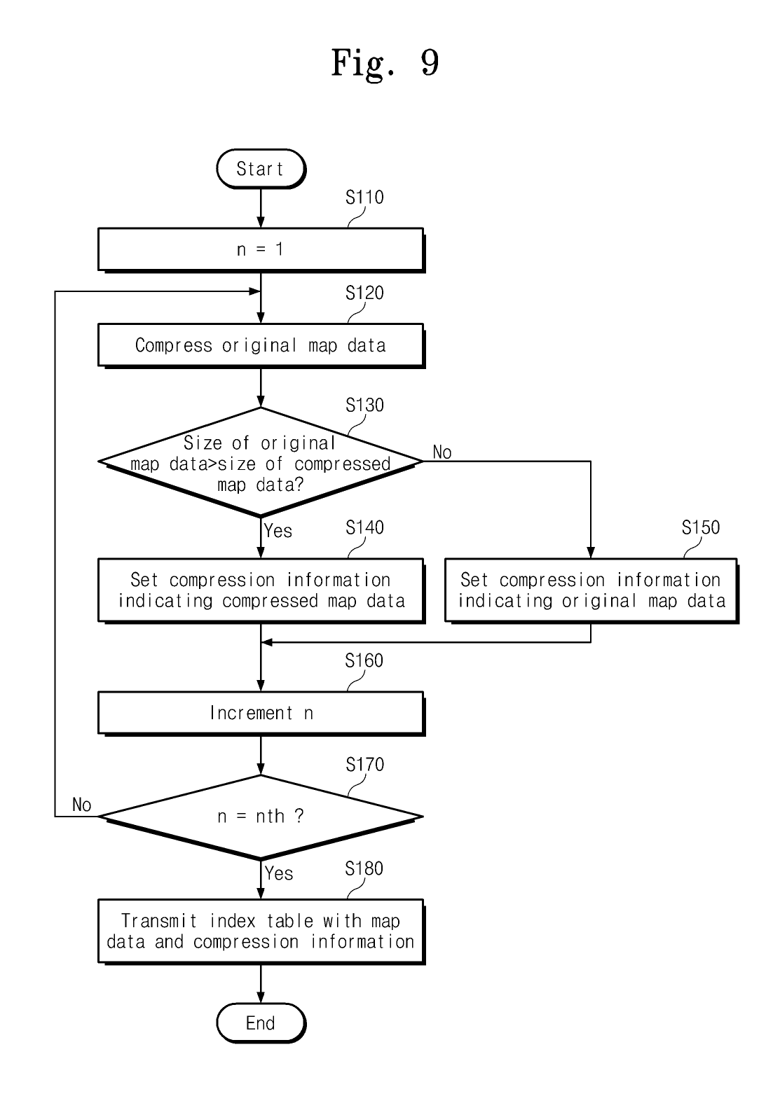

FIG. 9 is a flowchart illustrating a method of operating map data transmitting apparatus 100 of FIG. 2. In the description that follows, example method steps are indicated by parentheses (SXXX).

Referring to FIG. 9, parser 120 sets an index “n” to an initial value ‘1’ (S110). Next, encoder 130 compresses original map data of cell “n” (S120). Encoder 130 compresses the original map data to generate compressed map data for cell “n”.

Thereafter, map data generator 140 compares the size of the original map data of cell “n” with the size of the compressed map data of cell “n” (S130). Where the size of the original map data is greater than the size of the compressed map data (S130=Yes), index table generator 150 sets compression information, such as a compression flag, to indicate that map data for cell “n” is compressed map data (S140), and map data generator 140 stores the compressed map data.

Where the size of the original map data is not greater than the size of the compressed map data (S130=No), index table generator 150 sets the compression information to indicate that map data for cell “n” is original map data (S150). In operations S140 and S150, index table generator 150 receives information for setting the compression flags from map data generator 140.

After compression information is set by operation 5140 or 5150, parser 120 increments the value of “n” by 1. Thereafter, parser 120 determines whether “n” has reached a critical value “nth” (S170). Where “n” has reached the critical value (S170=Yes), transmitter 160 transmits the map data (compressed map data and original map data) and the index table comprising compression information to map data receiving apparatus 200 (S180). Otherwise (S170=No), the method returns to operation S120.

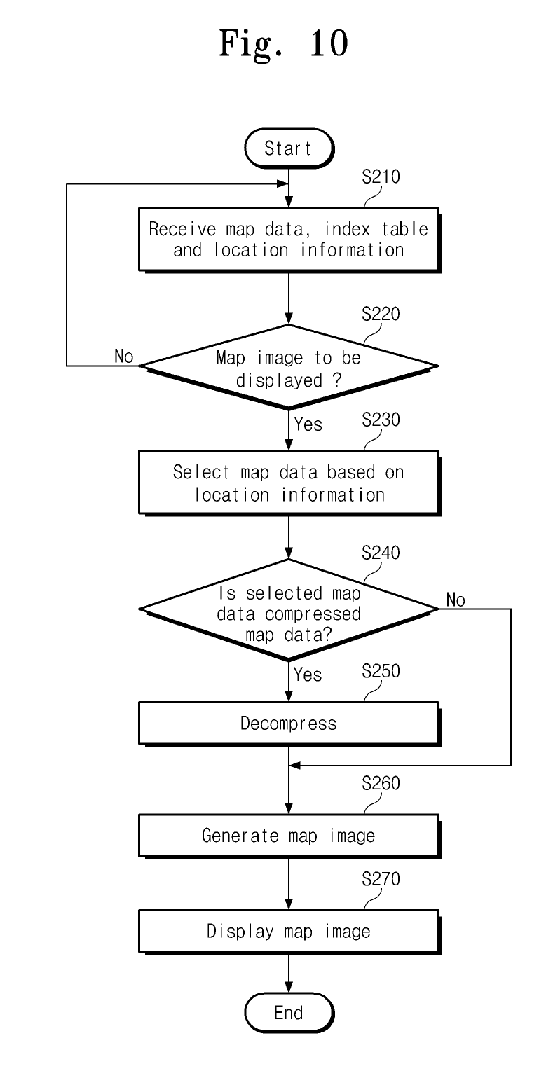

FIG. 10 is a flowchart illustrating a method of operating map data receiving apparatus 200 of FIG. 3.

Referring to FIG. 10, receiver 210 receives the map data, the index table, and the location information (S210). Receiver 210 receives the index table and the map data from map data transmitting apparatus 100 and receives the location information from a GPS satellite or other location detection mechanism. Receiver 210 provides the received map data to parser 230. Parser 230 stores the map data in memory 220. Receiver 210 provides the index table and the location information to map data recovery unit 250.

Next, map data recovery unit 250 determines whether to display a map image comprising the map data (S220). Where the map image is not to be displayed (S220=No), the method returns to operation 5210. In operation 5210, receiver 210 can receive location data according to the movement of map data receiving apparatus 200. In addition, receiver 210 can receive updates of map data and the index table.

Where the map image is to be displayed (S220=Yes), map data recovery unit 250 selects the map data to be incorporated in the displayed image according to the location information (S230). Then, map data recovery unit 250 examines the index table to determine whether the selected map data is compressed (S240).

Parser 230 receives the index table via map data recovery unit 250 and receiver 210. Parser 230 can also receive other information from map data recovery unit 250, such as identifiers of specific cells in the selected map data that contain compressed map data.

Where the compression information indicates that the selected map data is compressed map data (S240=Yes), decoder 240 decompresses the selected map data (S250), and the method proceeds to operation 5260. Otherwise (S240=No), the method proceeds to operation 5260 without decompressing the selected map data.

Decoder 240 receives the compressed map data from parser 230. Parser 230 can extract corresponding compressed map data from memory 220 by using information regarding the compressed map data from map data recovery unit 250.

After operation 5240 or 5250, map image generator 260 receives selected map data from map data recovery unit 250 and generates a map image based on the map data (S260). Map data recovery unit 250 outputs the map data to map image generator 260 to generate a map image using original map data decompressed by decoder 240 and original map data stored in memory 220. Next, display unit 270 displays the map image generated by map image generator 260 to provide a navigation service (S270).

Map data transmitting apparatus 100 can reduce the size of stored map data by compressing the original map data where the size of the compressed map data is smaller than the size of the original map data. Due to the reduced size of the map data, map data transmitting apparatus 100 and map data receiving apparatus 200 can make efficient use of limited storage space. In addition, map data transmitting apparatus 100 can improve its timing for transmitting map data to map data receiving apparatus 200.

Although cells of map data have been described with rectangular shapes, the cells can be arranged in alternative shapes or lattice structures, such as triangles, pentagons, and hexagons. Moreover, in various alternative embodiments, the map data can be compressed using any of several compression techniques or standards, such as moving picture experts group-4 (MPEG-4) or other standards.

As indicated by the foregoing, an apparatus for transmitting or receiving map data in a navigation system can store a larger amount of information by compressing original map data where the size of compressed map data is smaller than corresponding original map data. In addition, an apparatus for transmitting map data can reduce the time required to transmit a map by compressing map data as described above.

The foregoing is illustrative of embodiments and is not to be construed as limiting thereof. Although a few embodiments have been described, those skilled in the art will readily appreciate that many modifications are possible in the embodiments without materially departing from the novel teachings and advantages of the inventive concept. Accordingly, all such modifications are intended to be included within the scope of the inventive concept as defined in the claims.

What is claimed is:

1. An apparatus for transmitting map data, comprising:
a memory that stores original map data;
an encoder that encodes the original map data to generate compressed map data;
a map data generator that selects the original map data or the compressed map data based on a size of the compressed map data relative to the original map data, and stores the selected map data in the memory;
an index table generator that generates an index table comprising compression information indicating whether the selected map data is compressed map data; and
a transmitter that transmits the selected map data and the index table.

2. The apparatus of claim 1, further comprising a parser that extracts the original map data from the memory as a cell unit, and provides the extracted original map data to the encoder, wherein the cell unit is a unit lattice structure of a map.

3. The apparatus of claim 2, wherein the memory comprises an original cell buffer that stores the original map data as the cell unit and a compressed cell buffer that stores the compressed map data as a cell unit.

4. The apparatus of claim 1, wherein the map data generator selects the compressed map data upon determining that the compressed map data has a smaller size than the original map data.

5. The apparatus of claim 1, wherein the map data comprises three-dimensional topographical information.

6. The apparatus of claim 2, wherein the map data generator receives the original map data from the parser and receives the compressed map data from the encoder and compares the size of the compressed map data with a size of the original map data.

7. The apparatus of claim 1, wherein the encoder compresses the original map data using moving picture experts group-4 (MPEG-4) compression.

8. The apparatus of claim 1, wherein the index table further comprises a cell identifier indicating a location of the selected map data within a map image.

9. The apparatus of claim 3, wherein the index table further comprises an offset indicating a location of the original cell buffer or the compressed cell buffer.

10. The apparatus of claim 1, wherein the transmitter transmits the selected map information and the index table using wireless transmission.

11. An apparatus for receiving map data, comprising:
a memory;
a receiver that receives location information, map data, and an index table;
a parser that, in response to a map recovery signal, identifies selected map data to be displayed by the apparatus, distinguishes different portions of the selected map data as original map data and compressed map data, and extracts the original map data from the memory;
a decoder that decodes the compressed map data to generate decoded original map data;
a map data recovery unit that generates the map recovery signal based on the location information, receives the extracted original map data from the parser and the decoded original map data from the decoder, and outputs the selected map data in the form of the extracted original map data and the decoded original map data;
a map image generator that receives the selected map data output by the map data recovery unit and generates a map image from the selected map data; and
a display unit that displays the generated map image.

12. The apparatus of claim 11, wherein the memory comprises an original cell buffer that stores the original map data in cell units and a compressed cell buffer that stores the compressed map data in cell units.

13. The apparatus of claim 12, wherein the parser distinguishes the different portions of the selected map data as original map data and compressed map data according to information stored in the index table.

14. The apparatus of claim 13, wherein the index table comprises cell identifiers for cells of map data.

15. The apparatus of claim 14, wherein the cell identifiers correspond to locations of the map data within the map image.

16. The apparatus of claim 11, wherein the apparatus is a portable navigation system.

17. A method of operating a navigation system, comprising:
generating compressed map data by encoding original map data;
comparing a size of the original map data with a size of the compressed map data;
selecting the original map data or the compressed map data according to the comparison;
generating an index table indicating whether the selected map data is compressed; and
transmitting the selected map data and the index table.

18. The method of claim 17, wherein generating the compressed map data comprises encoding a cell unit of the original map data to generate a cell unit of the compressed map data, wherein the cell unit is a unit of a lattice structure formed by dividing a map.

19. The method of claim 17, further comprising:
receiving location information indicating a location of a receiving apparatus;
receiving the selected map data and the index table;
storing the received selected map data in a memory;
identifying display data comprising map data to be displayed by the receiving apparatus;
identifying different portions of the display data as original map data and compressed map data according to the index table;
decoding the portions of display data identified as compressed map data;
recovering from the memory the portions of display data identified as original map data;
generating a map image from the decoded portion of the display data and the recovered portions of the display data; and
displaying the generated map image.

20. The method of claim 19, wherein the portions of display data identified as compressed map data are decoded in cell units corresponding to areas of an image lattice.
